(19) United States
(12) Patent Application Publication
(10) Pub. No.: US 2025/0067471 A1
(43) Pub. Date: Feb. 27, 2025

(54) ROTARY APPARATUS FOR HEATING FLUIDS AND FOR RECYCLING HEATED FLUIDS, RELATED METHOD AND USES

(71) Applicant: Coolbrook Oy, Helsinki (FI)

(72) Inventor: Veli Matti PUROLA, Helsinki (FI)

(21) Appl. No.: 18/813,453

(22) Filed: Aug. 23, 2024

(30) Foreign Application Priority Data
Aug. 24, 2023 (FI) 20235939

(51) Int. Cl. F24H 3/02; F24H 9/00

(52) U.S. Cl. CPC F24H 3/02; F24H 9/0073; F24H 9/0084

(57) ABSTRACT

A rotary apparatus for inputting thermal energy into fluids and for recycling thus heated fluids is provided, comprising: a rotor with at least one row of rotor blades arranged over a circumference of a rotor hub mounted on a rotor shaft and forming at least one rotor blade cascade, respectively, and a plurality of stationary vanes arranged into at least one stationary vane cascade adjacent to said at least one rotor blade cascade, wherein the rotor and the plurality of stationary vanes are enclosed in a duct formed in a casing between at least one inlet and at least one outlet. The rotary apparatus is configured to heat fluids flowing in the duct between at least one inlet and at least one outlet by virtue of series of energy transformations occurring when said fluid successively passes through rotating and stationary blades/vanes, whereby a stream of heated fluid is generated, and to recycle at least a part of thus heated fluid by means of a fluid circulation arrangement configured to return a part of heated fluid into a duct region between at least one inlet and at least one rotor blade cascade. Recycling may be internal or external.

### FIELD OF THE INVENTION

The present invention relates to the field of rotary turbomachines with fluid/gas recycling systems. In particular, the invention concerns a rotary apparatus for heating fluids by converting kinetic energy of fluids to thermal energy and further equipped with a fluid (re) circulation system which improves thermal efficiency of the apparatus and enables further optimization of related hardware.

### BACKGROUND

A concept of rotary turbomachine-type device configured to convert mechanical energy of rotating rotor blades and hence kinetic energy of fluids to thermal energy (heat) has been originally disclosed in the U.S. Pat. No. 9,494,038 (Bushuev). Since then, different implementations of such rotary devices have been described in U.S. Pat. No. 9,234,140 (Seppälä et al), and −10,744,480 (Xu & Rosic). Amongst those, U.S. Pat. Nos. 9,494,038 and 9,234,140 concern rotary reactors comprising a rotor disk with associated blade cascade disposed between the rows of stationary blades (stator cascades) arranged on essentially ring-shaped supports and enclosed within a toroid-shaped gas casing. U.S. Pat. No. 9,234,140 also outlines an axial reactor, where rotating and stationary blades are arranged in an essentially tubular casing, while U.S. Pat. No. 10,744,480 describes a radial-flow turbomachine based reactor configuration. These disclosures generally concern reactor devices for converting hydrocarbon feedstocks into light olefins via thermo (chemical) cracking. Hydrocarbon feedstock-containing gas enters the interior of the reactor via inlet(s) and passes through rotating and stationary cascades several times prior to exiting the reactor. In each pass, process gas is heated in a stepwise manner to achieve average cracking temperatures, such as about 750-1000 degrees Celsius (° C.), more typically 820-950° C., at several final passes.

Recently it has been demonstrated that the rotary bladed device(s), such as the ones described hereinabove, may be rendered with a (pre) heater functionality capable of providing significantly higher amounts of (thermal) energy into high temperature heat intensive processes and associated equipment. These are a variety of industrial processes such as for example processing of non-metallic minerals to manufacture cement for example, production of hydrogen from natural gas, incineration of end-of-life plastics, chemical industry high-temperature heat processes (e.g. core processes to crack hydrocarbons into bulk chemicals and to transform limestone to cement clinker), iron and steel production (e.g. core processes to melt and form steel) and utilization of thus produced off-gases as a feedstock for bulk chemicals. Most of the above-mentioned processes require high- and extremely high temperature, such as within a range of about 850° C. to about 1600° C. To provide enough thermal energy for such processes, known rotary bladed device(s) still have a room for improvement.

However, described rotary devices encounter the following common drawbacks. For example, heating of gases having high specific heat (specific heat capacity) value, like hydrogen (with Cₚ 14.2 KJ/kg/K, where Cₚ is specific heat in a constant pressure process) in described rotary devices typically involves 10 to 20 passes (or even more) due to a low temperature rise in one heating pass. When the rotary apparatus is implemented with several rotor units mounted on a rotor shaft, such as in an axial design described in U.S. Pat. No. 9,234,140 (Seppälä et al), or in a radial flow turbomachine type design described in U.S. Pat. No. 10,744,480 (Xu & Rosic), each heating pass (also referred to as a stage) is determined with one such rotor unit with adjacent stationary components, such as stationary guide vanes and stationary diffuser; therefore, the rotor shaft length increases and so the temperature gradient between the rotor shaft and the apparatus casing also increases. This increases the risk of bending and reshaping of the rotor shaft and the casing in operation, as well as during start-up and shut down. Relatively long rotor shaft in described rotary devices further increases the risk of vibration.

Further, rotary devices designed for heating hydrogen, for example, and for some other high-temperature applications require rotor shaft and the casing to be made from special high-temperature alloys. Especially hydrogen increases risks of material failure. Large number of heating stages raises material-associated costs and complicates the machine design.

On the other hand, in the rotary apparatuses of a toroidal design, as described in U.S. Pat. No. 9,494,038 (Bushuev) and U.S. Pat. No. 9,234,140 (Seppälä et al), gas flows along a helico-toroidal pathway around an internal flow-shaping device in the form of a toroid (inner toroid) placed in an essentially ring-shaped gas casing (outer toroid), and a number of regenerative heating passes for regenerative work input are established with a single rotor blade row. Typical cracking reactions proceed in about ten (10) heating passes. However, heating of some substances requires more (e.g. 10 to 20) heating passes, which involves increased temperature gradient between the gas casing (outer toroid) and the flow-shaping device (inner toroid); therefore, the size of the rotary apparatus must also be increased, respectively. Large temperature gradients cause material stresses and shorten the life of hardware, such as the casing and other components.

It is further noted that selection of architecture in fluid machinery is typically driven by a ratio of available volumetric flow and required work duty. For example, for pressure-increasing turbomachines, a full axial compressor architecture may be preferred over a radial flow arrangement when large volumetric flows are available, whereas radial flow arrangement is typically selected to handle small volumetric flows. The extension of such analogy can be applied at different configuration of rotary bladed devices described herewith. Taken that the primary design objective of these rotary bladed devices is heating fluids passing therethrough, any one of: (a) processing of lightweight, low-density gases (e.g. hydrogen, helium), and (b) presence of an endothermic reaction in the gas path imply that a higher work input is required to achieve a certain temperature rise. Since a maximum achievable work exchange between a rotor blade and fluid is proportional to the blade kinetic energy that material properties allow, in practice this means that for a fixed temperature rise, a hydrogen-operating rotary device will require a greater number of stages (about 14 stages more) than an air-operating rotary device. However, if the volumetric flow is too small, the gas path will shrink to the point that manufacturing constraints and leakage flows will dominate the aerodynamics design space and the rotary device will lose its aerodynamics needed for creating kinetic energy and heating fluids, accordingly.

In addition to above said, the rotary apparatuses described so far are commonly hindered with a slow start-up. Start-up has to be done slowly to avoid mechanical failure due uneven thermal expansion of components. Heating up of the rotary devices at start-up is typically implemented using a frequency converter to allow controlled temperature rise. Frequency converters convert the defined frequency and voltage of the electrical energy into a variable frequency and voltage. In this way, the speed and torque of motors and related machines can be adapted to the requirements of a particular industrial application. However, frequency converters are expensive, and their maintenance and repair are associated with additional costs.

In this regard, an update in the field of improving efficiency of rotary bladed devices employed in thermal processing of fluids is still desired in view of addressing challenges associated with capability of said devices to generate heated media.

### SUMMARY OF THE INVENTION

An objective of the present invention is to solve or to at least mitigate at least some of the problems arising from the limitations and disadvantages of the related art. One or more objectives are achieved by various embodiments of the rotary apparatuses comprising the fluid (re) circulation arrangement, related method for recycling fluids, and uses as defined herein.

In an aspect, a rotary apparatus for inputting thermal energy into fluids is provided, according to what is defined in the independent claim 1.

In an embodiment, the apparatus comprises:
a rotor comprising at least one row of rotor blades arranged over a circumference of a rotor hub mounted on a rotor shaft and forming at least one rotor blade cascade, respectively, and
a plurality of stationary vanes arranged into at least one stationary vane cascade adjacent to said at least one rotor blade cascade,
wherein the rotor and the plurality of stationary vanes are enclosed in a duct formed in a casing between at least one inlet and at least one outlet, the rotary apparatus being configured to impart thermal energy to fluid flowing in the duct between at least one inlet and at least one outlet by virtue of series of energy transformations occurring when said fluid successively passes through rotating blades and stationary vanes, whereby a stream of heated fluid is generated,
wherein the rotary apparatus further comprises a fluid circulation arrangement configured to return a part of heated fluid into a duct region between at least one inlet and at least one rotor blade cascade.

In an embodiment, the rotary apparatus comprises at least one stationary vane cascade formed with a plurality of stationary vanes arranged upstream of the at least one rotor blade cascade, which stationary vane cascade is configured as a stationary guide vane cascade. The fluid circulation arrangement is configured to return the part of heated fluid to an entrance of said at least one stationary guide vane cascade.

In an embodiment, the stationary guide vane cascade arranged upstream of the at least one rotor blade cascade is a headmost stationary vane cascade which receives fluid entering the rotary apparatus through at least one inlet and directs said fluid towards a subsequent rotor blade cascade, and the fluid circulation arrangement is configured to return the part of heated fluid to an entrance of said headmost stationary vane cascade.

In an embodiment, in addition to at least one stationary vane cascade formed upstream of the at least one rotor blade cascade and configured as stationary guide vane cascade, the rotary apparatus further comprises at least one stationary vane cascade formed with a plurality of stationary vanes arranged downstream of the least one rotor blade cascade, which downstream stationary vane cascade is configured as a stationary diffusing vane cascade. In such configuration, the fluid circulation arrangement can be configured to extract a part of fluid exiting said at least one diffusing vane cascade.

In an embodiment, the fluid circulation arrangement is configured to extract a part of heated fluid exiting the rotary apparatus via at least one outlet.

In an embodiment, the rotary apparatus comprises at least two rotor blade cascades coaxially arranged on the rotor shaft. In an embodiment, the fluid circulation arrangement is configured to return the part of heated fluid into a duct region between the inlet and any one of these rotor blade cascades.

In an embodiment, the rotary apparatus further comprises a stationary guide vane cascade arranged upstream of a first rotor blade cascade of the at least two rotor blade cascades and optionally upstream of each subsequent rotor blade cascade, and a stationary diffusing vane cascade arranged downstream of at least a rearmost rotor blade cascade, respectively, and wherein the fluid circulation arrangement is configured to return the part of heated fluid exiting the diffusing vane cascade to the entrance of the stationary guide vane cascade arranged upstream of the first rotor blade cascade.

In an embodiment, the fluid circulation arrangement is arranged inside the casing. In such an event the fluid circulation arrangement can be configured as an internal piping or a conduit, a flowguide device or devices, or as an internal secondary shell. In an additional or alternative embodiment, the fluid circulation arrangement is configured as a piping arranged outside the casing.

In an embodiment, in said rotary apparatus, a portion of the duct between an exit from the at least one rotor blade cascade and an entrance to the stationary guide vane cascade is essentially free of blades/vanes. In another embodiment, in said rotary apparatus, a portion of the duct between an exit from the stationary diffusing vane cascade and an entrance to the stationary guide vane cascade is essentially free of blades/vanes.

In an embodiment, the fluid circulation arrangement comprises a number of flow regulating, devices, such as control valves, and flow dividing and mixing arrangements, configured to control a flow rate and/or pressure of recycled fluid.

In some embodiment, the apparatus comprises: a rotor comprising at least one row of rotor blades arranged over a circumference of a rotor hub mounted on a rotor shaft and forming at least one rotor blade cascade, respectively, and a plurality of stationary vanes arranged adjacent to said at least one rotor blade cascade and forming stationary vane cascades such that a headmost stationary vane cascade configured as a stationary guide vane cascade receives fluid entering the rotary apparatus through at least one inlet and directs said fluid towards a subsequent rotor blade cascade, wherein the rotor and the plurality of stationary vanes are enclosed in a duct formed in a casing between at least one inlet and at least one outlet, the rotary apparatus being configured to impart thermal energy to fluid flowing in the duct between at least one inlet and at least one outlet by virtue of series of energy transformations occurring when said fluid successively passes through rotating and stationary blades/vanes, whereby a stream of heated fluid is generated, wherein the rotary apparatus further comprises a fluid circulation arrangement configured to return a part of heated fluid to an entrance of the stationary vane cascade arranged upstream of said at least one rotor blade cascade. In an embodiment, the fluid circulation arrangement is configured to return a part of heated fluid to an entrance of the headmost stationary vane cascade.

In an aspect, use of the rotary apparatus according to some previous aspect and embodiments is further provided for heating fluids in an absence of a frequency converter device, according to what is defined in the independent claim 16. In another aspect, use of the rotary apparatus according to some previous aspect and embodiments with a drive engine, such as motor, configured to rotate the rotor shaft without a gearbox is further provided, according to what is defined in the independent claim 17.

In an aspect, an assembly comprising at least two rotary apparatuses according to some previous aspect and embodiments and at least functionally connected in parallel or in series is provided, according to what is defined in the independent claim 18. In an embodiment, in said assembly, the fluid circulation arrangement may be disabled or omitted in at least one of said at least two rotary apparatuses. In another aspect, an assembly comprising at least one rotary apparatus according to some previous aspect and embodiments and a preheater device arranged upstream of the at least one rotary apparatus is provided, according to what is defined in the independent claim 20.

In an aspect, an arrangement comprising at least one rotary apparatus according to some previous aspect and embodiments and connected to at least one heat-consuming unit is provided, according to what is defined in the independent claim 21. In an embodiment, the heat-consuming unit in said arrangement may be any one of: a furnace, an oven, a kiln, a reactor, a heater, a burner, an incinerator, a boiler, a dryer, a conveyor, or a combination thereof.

In a further aspect, a method for recycling fluids in the rotary apparatus is provided, according to what is defined in the independent claim 23.

In an embodiment, the method further comprises adjusting outlet temperature of the fluid propagated through the duct by regulating at least a flow rate of fluid recycled via the fluid circulation arrangement.

In an embodiment, in said method, the heated fluid generated in the rotary apparatus is gas.

In an embodiment, in said method, the heated fluid generated in the rotary apparatus is any one of: wherein the heated fluid generated in the rotary apparatus is any one of: air, steam (H₂O), nitrogen (N₂), hydrogen (H₂), oxygen (O₂), carbon dioxide (CO₂), carbon monoxide (CO), nitrogen oxides (NOx), ammonia (NH₃), sulfur dioxide (SO₂), halogen-containing gas, hydrocarbon-containing gas, or any combination thereof.

In an embodiment, in said method, the rotary apparatus is driven with an electrical motor optionally using electrical energy obtainable from renewable sources.

The utility of the present invention arises from a variety of reasons depending on each particular embodiment thereof.

Overall, recycling heated fluids (i.e. admixing at least a part of fluids heated in the rotary apparatus with feed/fluid that has not yet undergone heating) allows for improving energy efficiency of the rotary apparatuses, such as those described hereinabove. The invention is based on an observation that upon recycling of output fluid/gas, only minor energy losses occur relative to the heat input made by rotating blades of the rotor. To compensate for pressure losses in the recycle flow, the rotor can be configured to produce pressure head (only slight pressure rise is required). This is contrary to for example compressors and similar turbomachines not used to convert mechanical energy to heat, which encounter energy losses during recycle due to significant pressure losses; therefore, recycling of gases in such turbomachines is essentially useless.

The present invention generally concerns improvements to rotary apparatus describes hereinabove and hence it allows for achieving same target temperatures by using less heating passes/heating stages in the rotary apparatus and/or by adjusting the temperature rise (delta T, dT) achieved during each heating pass/heating stage to a smaller value (compared to known rotary devices described hereinabove). One of the notable benefits of the present invention is a possibility to adjust the dT value by modifying the tip speed of the rotor blades.

By having fluids recirculated/recycled, it is further possible to:
Achieve target temperatures with a smaller number of heating passes/heating stages, which enables, in some instances, using less rotor units/impellers and so reducing the length of the rotor shaft.
Optimize temperature rise (dT) achievable in one heating pass/heating stage in the rotary apparatus. Smaller temperature rise achieved in one pass/stage allows for reducing thermal gradients throughout the apparatus and smoothing out the total temperature rise to the target temperature. Accordingly, more uniform thermal profile across the rotor shaft can be achieved.
Use a rotor with larger rotor blades (i.e. with a larger airfoil chord length) which are optimal for increased fluid flow rates, which, in turn allows for reducing rotating speed of the rotor shaft.
Optimize rotating speed of the rotor shaft.
Eliminate a motor gearbox by controlling a flow of recycled fluid and adjusting the apparatus design according to the motor speed.
Eliminate variable speed controller by controlling a flow of recycled fluid.
Simplify mechanical structure of the rotary apparatus.
Implement rotary apparatuses with axial and radial design for smaller gas flow.

The invention efficiently solves the problem associated with multiple heating passes and long rotor shafts in rotary apparatuses of axial- and radial types. The invention also enables implementing controls over the gas heating with high precision in an absence of variable speed controller (commonly used in known rotary heaters to allow controlled temperature rise).

Applicability of the recycling concept to rotary reactor apparatuses depends on the process chemistry. Fluid (re) circulation/recycling arrangement disclosed herewith mixes inlet gas (feed) and recycle gas. Hence, proposed recycling arrangement is applicable to rotary apparatuses configured as rotary reactors if mixing of products and feed is allowed by the process.

The expression “a number of” refers hereby to any positive integer starting from one (1), e.g. to one, two, or three. The expression “a plurality of” refers hereby to any positive integer starting from two (2), e.g. to two, three, or four. The terms “first” and “second”, are used hereby to merely distinguish an element from another element without indicating any particular order or importance, unless explicitly stated otherwise.

The term “gasified” is utilized herein to indicate matter being converted into a gaseous form by any possible means.

Different embodiments of the present invention will become apparent by consideration of the detailed description and accompanying drawings.

### BRIEF DESCRIPTION OF THE DRAWINGS

FIG. 1 schematically illustrates, at 100, a rotary apparatus comprising a fluid circulation arrangement 10, according to the embodiments.

FIGS. 2A and 2B illustrate the rotary apparatus comprising the fluid circulation arrangement configured for internal and external recycling, respectively.

FIG. 3 schematically illustrates sequential connection between rotary apparatuses with- and without circulation arrangement, and integration thereof with a preheater 102.

FIGS. 4A, 4B, 5A and 5B illustrate exemplary embodiments of the rotary apparatus comprising fluid circulation arrangement 10 configured for internal recycle (FIGS. 4A and 5A), external recycle (FIG. 5B), or both (FIG. 4B).

### DETAILED DESCRIPTION OF THE EMBODIMENTS

Detailed embodiments of the present invention are disclosed herein with the reference to accompanying drawings.

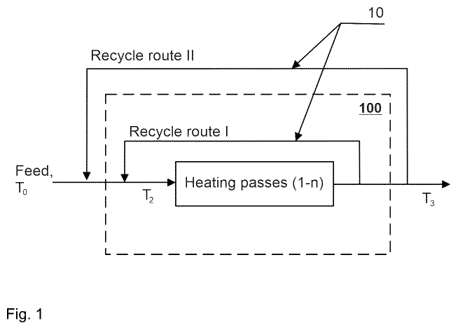

FIG. 1 schematically illustrates, at 100, respectively, exemplary embodiments underlying a concept of a rotary apparatus 100, hereafter, an apparatus, for heating fluids and for recycling (heated) fluids through a fluid circulation arrangement 10. Arrangement 10 is configured to return at least a part of fluid heated in the apparatus 100 essentially towards an inlet region, where said part of heated fluid is admixed with input (feed) fluid. In some configurations, the arrangement 10 is configured to (re) circulate fluid essentially between the apparatus inlet region(s) and outlet region(s). Therefore, the arrangement 10 can be viewed as an arrangement for recycling fluid within the apparatus 100.

The fluid circulation arrangement 10 is generally implemented in a rotary turbomachine-type apparatus 100 configured for heating fluids through a series of energy transformations aiming at converting mechanical energy of rotating rotor shaft to internal energy of the fluid and finally to thermal energy. The apparatus 100 comprises a casing with at least one inlet and at least one outlet, a rotor with a plurality of rotor blades arranged into at least one row about a circumference of a rotor hub mounted onto a rotor shaft, and a plurality of stationary vanes arranged adjacent to said at least one row of rotor blades, wherein the rotor and the plurality of stationary vanes are enclosed in a duct formed in the casing between at least one inlet and at least one outlet.

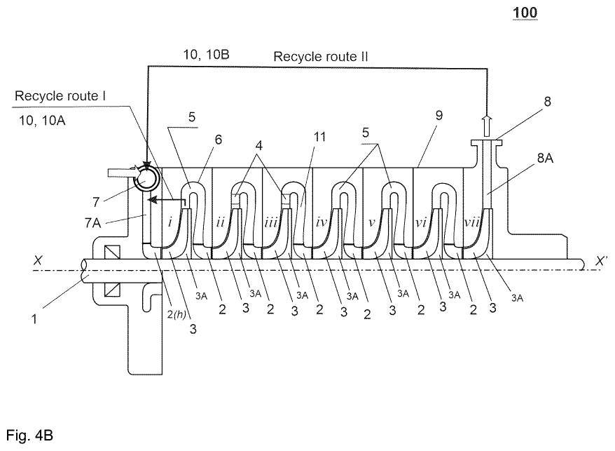

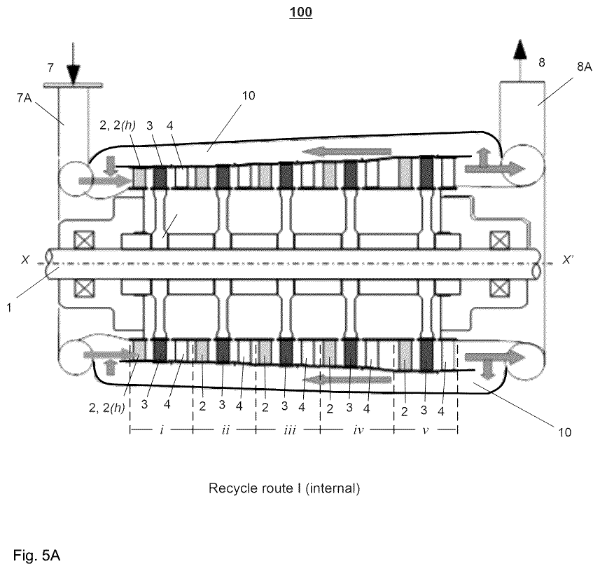

Exemplary configurations of the rotary apparatus 100 are shown on FIGS. 4A and 4B. It is further assumed that based on a following description, a skilled person would be capable to adapt rotary apparatuses of similar type to incorporate the fluid (re) circulation arrangement 10 discussed herewith.

In configuration shown on 4A and generally implemented in accordance with what is described in U.S. Pat. No. 9,234,140 to Seppälä, the rotary apparatus 100 is implemented as an essentially tubular, axial-type turbomachine. In such configuration, the apparatus comprises an extended rotor shaft or rotor hub, along which a plurality of rotor blades 3 is arranged into a number of sequential rows. The rotor is enclosed within the casing, inner surface of which is provided with the stationary (stator) guide vanes 2 and diffusing (diffuser) vanes 4, arranged such that blades/vanes of the stator, rotor- and diffusing cascades alternate along the rotor hub in a longitudinal direction (along the length of the rotor shaft, for inlet to exit). Blades of the rotor cascade at certain positions along the rotor in the longitudinal direction form the stage with the adjacent pairs of stationary guide (nozzle) vanes and diffusing vanes, respectively.

FIG. 4B, in turn, illustrates the rotary apparatus 100 in a so-called radial configuration outlined in the U.S. Pat. No. 10,744,480 to Xu & Rosic. In configuration of FIG. 4B, the apparatus 100 is configured as a radial turbomachine that generally follows a design for centrifugal compressors or centrifugal pumps. The term “centrifugal” implies that fluid flow within the device is radial; therefore, the apparatus may be referred, in the present disclosure, as a “radial-flow” apparatus. The apparatus comprises a number of rotor units with rotor blade cascades 3 mounted onto elongated shaft 1, wherein each rotor unit is preceded with stationary guide vanes 2. An essentially empty portion 5 of the duct (vaneless space) shaped in a manner enabling energy conversion (U-bend or S-bend, for example) is located after the rotor unit(s). Additionally, configuration may comprise a separate diffuser device implemented, in some instances, as a diffusing vane cascade 4 disposed downstream of selected rotor units or all rotor units.

In some other exemplary configurations, the rotary apparatus can be implemented substantially in a shape of a ring torus, where a cross-section of the duct in the meridian plane forms a ring-shaped profile, as discussed in detail in the U.S. Pat. No. 9,494,038 to Bushuev and −9,234,140 to Seppälä et al (not shown). Such an apparatus comprises a rotor unit disposed between stationary guide vanes (nozzle vanes), and stationary diffusing vanes. The stages are formed with rows of stationary nozzle vanes, rotor blades and diffusing vanes, through which the fluidic stream propagates, in a successive manner, following a flow path established in accordance with an essentially helical trajectory. In this configuration, fluidic stream circulates through the rotating rotor blade cascade a number of times according to the helico-toroidal pathway, while propagating inside the apparatus between the inlet and the exit. Similar toroid-shaped configuration is described in U.S. Pat. No. 9,494,038 to Bushuev.

Further, the apparatus 100 may be configured to direct the fluid along a flow path established with two spirals rolled up into vortex rings of right and left directions, as discussed in the patent document U.S. Pat. No. 7,232,937 to Bushuev (not shown).

The entire content of the above-mentioned documents is considered incorporated herein by reference.

Similar to these known devices, the apparatus 100 transfers the mechanical energy of rotating shaft to fluidic media and converts it into internal energy of the fluid through a set of rotating and stationary blade cascades. However, the apparatus 100 presented herewith further comprises a fluid (re) circulation (recycling) arrangement 10 which enables operation essentially without heat losses and generally allows for optimizing the process parameters (such as flow rate and pressure, outlet temperature of the fluid, etc.) and/or hardware design (a number of heating passes, blade design, rotor shaft length, rotor blade (tip) speed), and further—to eliminate the need in some typical components such as variable speed controllers and/or variable frequency drives.

The apparatus 100 is preferably configured for heating fluids. The apparatus is adapted for (direct) heating of fluids, preferably gasses, passing therethrough in a manner disclosed hereinbelow. In embodiments, the apparatus 100 can be advantageously used for generation of fluidic medium heated to temperatures essentially equal to or exceeding about 400° C. In embodiments, the apparatus may be adapted to generate fluidic medium heated to temperatures essentially equal to or exceeding about 1000° C., preferably, to temperatures essentially equal to- or exceeding about 1400° C., still preferably, to temperatures essentially equal to or exceeding about 1700° C. Temperatures up to 2000-2500° C. can be achieved upon application of appropriate cooling technologies.

Feed fluid may include one of: a feedstock liquid or gas, a process gas/working gas, a make-up gas (a so-called replacement/supplement gas), a recycle gas, and the like. Gaseous feed can include any gas, including but not limited to inert gases (steam, air, nitrogen gas, and the like), reactive gases (e.g. oxygen) and/or flammable gases, such as hydrocarbons. Additionally or alternatively, feed fluid may include any one of: (water) steam, nitrogen (N₂), hydrogen (H₂), carbon dioxide (CO₂), carbon monoxide (CO), nitrogen oxides (NOx), ammonia (NH₃), sulphur dioxide (SO₂), hydrocarbon-containing gas, halogen gas (e.g. chlorine), halogen-containing gases, or any combination thereof. As mentioned hereinabove, selection of fluid to be heated by the apparatus 100 depends on requirements of industrial process(-es), in which said fluid will be utilized, namely, whether the process allows for admixing products with feed. Hence, fluids heated in the rotary apparatus may generally undergo chemical conversion processes as far as admixing reaction products with (unreacted) feed as allowed by the process/industrial application. Indeed, a specific industry/an area of industry said heat-consuming process is assigned to implies certain requirements and/or limitations on selection of feed substance(s).

Fluid heated by the apparatus 100 may be further utilized for (indirectly) heat any other gaseous, liquid, solid or particulate matter, or combination thereof, via a process of heat transfer between the heated fluidic medium generated in the rotary apparatus and a suitable medium (solid, liquid, etc.) exploited by the exemplary heat-consuming process.

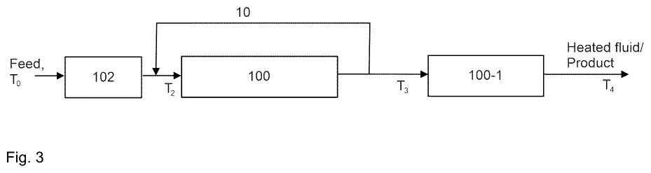

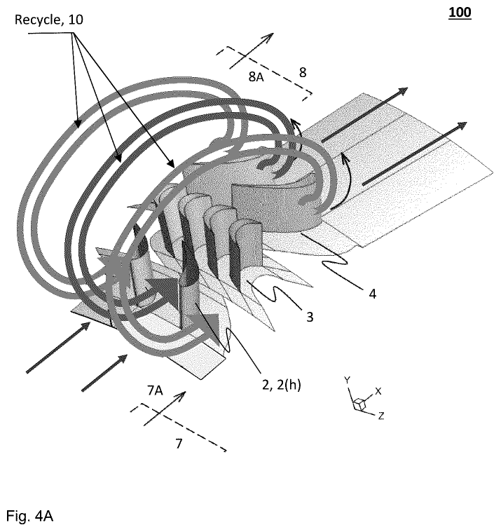

It is preferred that the feed enters the apparatus 100 in essentially gaseous form. Preheating of feed or conversion of liquid and essentially liquid feed(s) into a gaseous form can be performed in an optional preheater unit 102 (see FIG. 3).

The apparatus 100 comprises a rotor system, hereafter, a rotor, comprising at least one rotor shaft 1 positioned along a horizontal (longitudinal) axis X-X′ and one or more circumferential rows of rotor blades (also referred to as working blades), arranged in said at least one rotor shaft. In an event of two or more rows of rotor blades are used, they are arranged coaxially on at least one shaft. In typical configurations, a plurality of rotor blades is arranged into a circumferential row over a periphery of a rotor disk or a rotor hub 3A mounted on the rotor shaft 1 to form a rotor blade cascade 3 (working blade cascade). In some embodiments, the apparatus comprises two or more circumferential rows of rotor blades coaxially arranged on at least one shaft and forming respective rotor blade cascades 3 (see FIG. 4B, for example).

At least one rotor shaft 1 is rotated by a suitable drive engine/motor to provide rotational angular velocity to each of the rotor blade cascades. In some configurations, the apparatus utilizes electric motor(s) as a drive engine. Additionally or alternatively the apparatus can be driven directly by a power turbine, such as gas- or steam turbine, for example, or by any other suitable drive engine device. For the purposes of the present disclosure, any appropriate type of electric motor (i.e. a device capable of transferring energy from an electrical source to a mechanical load) can be utilized. Suitable coupling(s) arranged between a motor drive shaft and the rotor shaft, as well as various appliances, such as power converters, controllers and the like, are not described herewith. Use of the fluid (re) circulation arrangement 10 enables implementing the rotary apparatus without a frequency controller device, which are typically used for variable speed control of electric motors.

The apparatus 100 further comprises a stationary component. Stationary component is represented with a plurality of stationary (stator) blades or vanes arranged into assemblies or rows 2, 4 adjacent to at least one rotor blade cascade. These stationary blade assemblies/rows form stationary vane cascades, respectively. In the present disclosure, working- or rotor blades are referred to with the term “blades”, while stationary blades are referred to with the term “vanes”.

The term “cascade” (a crown of blades/vanes) refers to an ensemble of (working) blades or (stationary) vanes installed over a periphery of a rotor disk/rotor hub (for working blades) or on a ring-shaped support installed within casing or on an internal wall/lining of the casing (for stationary vanes), respectively. Entrance (inlet) to the blade/vane cascade is generally defined with leading edges of related blades/vanes, whereas the exit from the cascade is defined with trailing edges of said blades/vanes. The entrance and exit are defined in a direction of fluid flow.

The terms “upstream” and “downstream” refer hereby to spatial and/or functional arrangement of structural parts or components with relation to a predetermined part- or component, hereby, the rotor, in a direction of fluidic flow stream throughout the apparatus (from inlet to exit).

With the term “stationary” we refer to blades/vanes not rendered with rotational movement around the axis X-X′ (as contrary to the rotor blades). It is noted that attachment of stationary vanes to the casing (internal wall or lining thereof) may be fixed (non-movable) or essentially movable. In a latter case attachment of stationary vane(-s) may employ some degree of movement, allowing adjustment of the blade angle, to some extent, with regard to the rotor blades and/or the interior of the casing. Stationary blades/vanes may be attached directly to the casing (internal wall and/or lining thereof) or via auxiliary connector means such as for example rails, ring-shaped support frame, etc. Movable connection may be realized by hinged joints, or any other appropriate connection means.

In some configurations, the plurality of stationary vanes can be arranged into a stationary vane cascade (a stator), provided as an essentially annular assembly upstream of the at least one row of rotor blades. The stationary vanes arranged into the assembly disposed upstream of the at least one row of rotor blades may be provided as stationary guide vanes 2, such as (inlet) guiding vanes (IGV), and be configured, in terms of profiles, dimensions and disposition thereof around the central shaft, to direct the fluid flow into the rotor in a predetermined direction such, as to control and, in some instances, to maximize the rotor-specific work input capability.

In an event the apparatus 100 comprises at least two rows of rotor blades (rotor blade cascades) sequentially arranged on/along the rotor shaft, the stationary guide vanes may be installed upstream of the first row of the rotor blades, upstream of each row of rotor blades in the sequence, or upstream of any selected row of rotor blades in a sequential arrangement of the latter.

In embodiments, the rotary apparatus 100 further comprises a diffuser arranged downstream of the at least one row of rotor blades (rotor blade cascade). The diffuser can be vaned or vaneless. Vaned diffuser comprises a plurality of stationary diffusing vanes arranged into a diffusing vane cascade 4, provided as an essentially annular assembly downstream of one or more rotor blade cascades.

The apparatus 100 further comprises a casing 6 referred to as a gas casing or a pressure casing, in where an interior passageway is established in the form of a duct 11 between at least one inlet 7 and at least one outlet 8. The casing 6 is hermetically (gas-tight) sealed. In present disclosure, the gas casing is generally referred to as an apparatus casing. Nevertheless, the apparatus structure 100 can be further enclosed into a separate external housing. External housing may be advantageous when the gas casing 6 has a complex shape (see 4B, for example, where external housing is indicated with a reference numeral 9). The rotor, and stationary components are enclosed within said internal passageway (duct 11) formed in the casing.

In some configurations, such as described for example in U.S. Pat. No. 10,744,480 to Xu and Rosic, provision of a separate diffuser (device) may be omitted, and dissipation of kinetic energy into internal energy of the fluid resulting in heating said fluid is realized in a portion 5 of the duct 11 located downstream of the rotor blade cascade 3 and being essentially void of blades/vanes and/or any other structures (and so referred as a vaneless space) (FIG. 4B). This essentially empty portion of the duct is configured, in terms of its geometry and/or dimensional parameters, to diffuse a high-speed fluid flow arriving from the rotor. For clarity it is noted that configuration of FIG. 4B comprises a number of heating stages with the diffusing vane cascade 4 (stages ii and iii) and without the diffusing vane cascade (stages i and iv-vii).

Provision of this essentially empty portion of the duct is common for all configurations of the rotary apparatus 100 described above. Depending on configuration, this portion of the duct (vaneless space) is arranged downstream of the rotor blades (rf. U.S. Pat. No. 10,744,480 to Xu and Rosic; see also FIG. 4B where vaneless space is indicated with reference no. 5) or downstream of the diffusing vane cascade (rf. U.S. Pat. No. 9,494,038 to Bushuev and U.S. Pat. No. 9,234,140 to Seppälä et al). In some configuration described for example by Seppälä et al, arrangement of rotating and stationary blade rows in the internal passageway within the casing is such that vaneless portion(s) is/are created between an exit from the stationary diffusing vanes disposed downstream of the rotor blades and an entrance to the stationary guide blades disposed upstream of the rotor blades of a subsequent rotor blade cascade unit.

Overall, the rotor with the at least one working blade cascade can be positioned between the rows of stationary (stator) vanes arranged into essentially annular assemblies (referred to as cascades). The stationary vane cascade(s) can thus be positioned at one or both sides of the working blade row. Configurations including two or more rows of rotor blades/rotor blade cascades arranged in series (in sequence) on/along the rotor shaft may be conceived with or without stationary blades in between. In an absence of stationary vanes between the rotor blade rows, the speed of fluidic medium propagating through the duct increases in each subsequent row. In such an event, a plurality of stationary vanes may be arranged into assemblies upstream of a first rotor blade cascade in said sequence (as stationary guide vanes) and downstream of a rearmost (lastmost) rotor blade cascade (as stationary diffusing vanes).

The row of rotor blades (rotor blade cascade 3) and a portion of the duct (region 5, FIG. 4B) downstream of said rotor blades enclosed inside the casing may be viewed as a minimal heating stage (heating pass), configured to mediate a complete energy conversion cycle. Hence, an amount of kinetic energy added to the stream of fluidic medium by at least one row of rotating blades is sufficient to raise the temperature of the fluidic medium to a predetermined value when said stream of fluidic medium exits the rotor blades and propagates, in the duct, towards a subsequent row of rotor blades, or enters the same row of rotor blades following an essentially helical trajectory formed within the essentially toroidal-shaped casing (in a latter case the heating stage is referred to as a regenerative heating pass). The duct (which encloses the periphery of the rotor) is preferably shaped such, that upon propagation of the fluidic stream in the duct, the stream decelerates and dissipates kinetic energy into an internal energy of the fluidic medium, and an amount of thermal energy is added to the stream of fluidic medium.

In embodiments, the heating stage/heating pass further includes a row of stationary diffusing vanes (stationary diffusing vane cascade 4) arranged downstream of a row of rotor blades 3 and/or a row of stationary (guide) vanes (stationary guide vane cascade 2) positioned upstream of a row of rotor blades 3. It some embodiments involving two or more rotor blade cascades, the stationary guide vane cascade 2 can be arranged prior to a first or headmost row of rotor blades and the stationary diffuser (or diffusing vane cascade) is arranged after a second or rearmost (lastmost) row of rotor blades.

In some embodiments, the heating stage/heating pass is thus established with an arrangement formed with stationary guide vanes 2, rotor blades 3 and stationary diffusing vanes 4, as shown on FIG. 4A.

The rotary apparatus can include 1 to n heating passes, where n is typically 1-20. However, the number of heating passes can be even higher in case low-density gases, like hydrogen or other special gases are utilized.

Overall, in the apparatus 100, fluid propagates in the duct 11, between at least one inlet 7 and at least one outlet 8. In embodiments, a stationary vane cascade positioned downstream an inlet region 7A of the duct is configured to receive fluid entering the rotary apparatus through at least one inlet and to direct said fluid towards a subsequent rotor blade cascade. In the apparatus 100, the stationary vane cascade that receives the fluid entering through inlet(s) is typically a headmost stationary vane cascade in a number of stationary vane rows/cascades. Said headmost stationary vane cascade is preferably configured as a stationary guide vane cascade. Dependent on configuration of the apparatus 100, the headmost stationary vane cascade (indicated with a reference number 2(h), where (h) stands for headmost) may be the only stationary guide vane cascade in the apparatus 100, or a first stationary guide vane cascade in a number of stationary guide vane cascades preceding each impeller unit (with the rotor blade cascade). Respective configurations are shown on FIGS. 4A and 4B, respectively.

Fluid to be heated (feed fluid) enters the duct via at least one inlet 7 and proceeds to a first or headmost row of stationary vanes 2(h) via the inlet region 7A of the duct. Inlet region 7A may be implemented as a duct portion, such as for example a channel, a conduit or a duct space of any suitable shape, between the inlet port and the headmost row of stationary vanes. In similar manner, heated fluid is withdrawn from the apparatus 100 via at least one outlet 8 preceded with an outlet duct portion 8A (outlet duct region) of any suitable shape.

Additionally or alternatively, the heated fluid can be returned into a duct region located between at least one inlet and at least one rotor blade cascade.

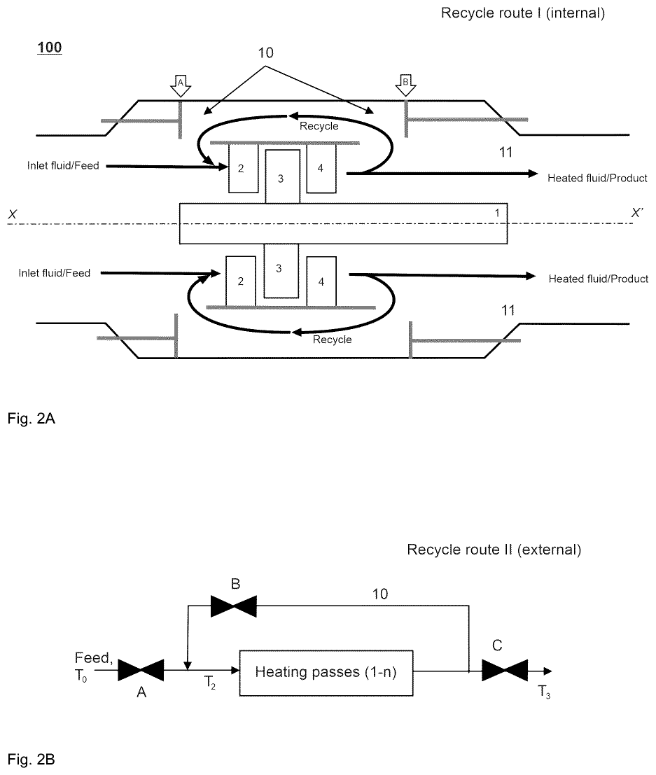

Reference is made back to FIG. 1 and further—to FIGS. 2A and 2B showing the concepts of internal and external (re) circulation/recycling, respectively.

Fluid circulation arrangement 10, 10A can be provided inside the rotary apparatus, as an internal part thereof to implement internal recycle (Recycle route I, FIG. 1). Fluid circulation arrangement 10, 10A for internal recycling can thus be implemented with an internal piping or a conduit, or with a flowguide device or a number of flowguide devices arranged in the duct to direct the recycled fluid flow essentially towards the inlet (not shown). In an embodiment, the fluid circulation arrangement 10A is configured as a secondary shell (lining) provided inside the gas casing around the blade cascades. Once the fluid has entered the internal duct 11 and has propagated through the blade/vane cascades towards the outlet region 8A, part of the heated fluid is directed to the secondary shell, and, via said secondary shell, back to the inlet region 7A. A recycle flow path is this established inside the secondary shell.

Additionally or alternatively, fluid circulation arrangement 10, 10B can be built outside the rotary apparatus (i.e. outside the gas casing 6) (Recycle route II, FIG. 1). In a latter event, the arrangement 10 may be implemented as a piping or channel(s) connected with the duct 11.

FIG. 2A shows a concept of internal fluid (re)circulation/recycling in the apparatus 100 of a most basic axial design (rf. U.S. Pat. No. 9,234,140 to Seppälä et al.). In embodiment, internal recycling is implemented with the fluid circulation arrangement 10 configured to return fluid exiting the diffusing vanes 4 arranged downstream of a rotor blade cascade 3 to the stationary guide vanes 2 arranged upstream of the same rotor blade cascade within the duct 11 arranged inside the casing 6. Arrows A and B indicate possible places, where internal flow can be controlled with a regulating device, such as a damper or a slotted ring. In some other configurations, fluid may be withdrawn from any subsequent heating pass/heating stage and transferred the headmost stationary guide vane cascade. In this axial arrangement, the headmost stationary guide vane cascade is the stationary guide vane cascade arranged upstream of the first rotor blade cascade. The number of heating passes/heating stages can vary. Typically, the apparatus 100 is implemented with 1-20 heating passes.

By way of example, the regulating device(s) can be configured to move in axial (longitudinal) direction (along the axis X-X′). Such reciprocating, plunger-like movement may open and close a recycle flow path at the inlet or outlet of the rotary apparatus, whereby the inlet/feed flow may be mixed with the recycle flow, and the recycle flow may be divided from the outlet flow, respectively. In some configurations, the regulating device may be provided in the form of a ring-shaped plunger.

Concept of internal recycle realized in an axial implementation of the rotary apparatus 100 comprising sequential rows of stationary guide vanes 2, rotor blades 3 and stationary diffusing blades 4 is shown on FIG. 4A. Plate above the vanes/blades 2, 3 and 4 is not shown. In FIG. 4A, inlet fluid/gas or feed gas is mixed with recycle flow and distributed towards the stationary guide vane cascade 2 located next to the inlet region 7A. In operation, total flow passes through the rotor blade cascade 3 and the diffuser 4. After the diffuser, the heated gas flow is divided to a recycle stream and an exit stream (heated fluid or product), which have the same temperature. Angle of diffusing blades is designed so that gas exiting the diffuser has an axial direction.

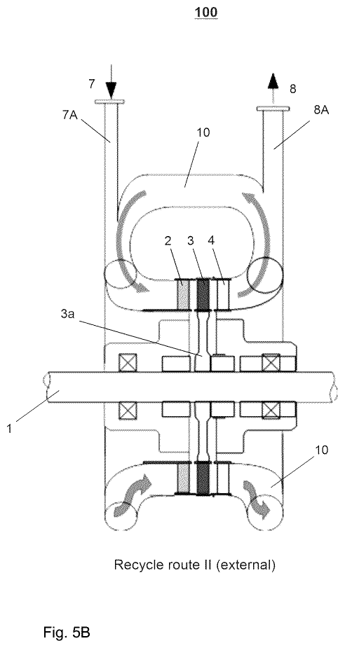

Internal recycle for the axial implementation of the rotary apparatus 100 comprising five sequential stages (i-v), wherein each stage is formed with a row of stationary guide vanes 2, a row rotor blades 3 and a row stationary diffusing blades 4 is shown on FIG. 5A. Entrance and exit of the fluid in/out of the apparatus 100 is tangential. Recycle flow is shown with arrows.

Internal recycling for the radial-configuration is shown on FIG. 4B (Recycle route I, 10, 10A). In internal recycle, fluid exiting the rotor blades or, in some instances, diffusing vanes, is recycled, within the duct 11 and/or within the apparatus casing 6 back into the inlet region 7A to be returned essentially at the entrance to the headmost stationary vanes 2, 2(h).

FIG. 2B shows a concept of external fluid (re) circulation/recycling in the apparatus 100 of any design described hereinabove. In external recycle, the fluid exiting the diffuser is returned to stationary guide vanes using the fluid circulation arrangement 10 implemented as an external piping or a conduit. FIG. 2B further shows, at A, B and C, where flow regulating devices, e.g. flow control valves, can be arranged. Additionally or alternatively, the flow regulating device can be adapted for mixing and/or dividing the flow, and provided as a three-way valve, for example.

Flow control principles shown on FIG. 2B for inlet(s)/outlet(s) (A, C) can also be utilized in internal recycle configuration shown on FIG. 2A. The flow control may be further implemented over the internal and external recycle in combination.

Implementation of external recycling is shown on FIG. 4B (Recycle route II, 10, 10B) and FIG. 5B. FIG. 4B illustrates how, in external recycling, the heated fluid flow exiting the apparatus 100 through the outlet 8 is returned back to the inlet region 7A. Externally recycled flow can be admixed to inlet fluid before it enters the apparatus 100 or delivered into the inlet region of the duct (conduit 7A) through the same or separate inlet port. FIG. 5B illustrates a single-stage rotary apparatus 100 in its axial implementation with tangential inlet and outlet flow (recycle flow is shown with arrows).

It is noted that both internal and external recycle routes can be combined in the single apparatus (see FIG. 4B), where recirculation is a combination of internal and external recycle.

The fluid (re) circulation arrangement 10 can be further configured to return recycle gas stream to any (heating) stage (in addition to or alternatively to a first/headmost heating stage), according to the temperature of recycled gas. In such an event, a part of heated fluid is directed from an exit point (which can be outlet duct region 8A or any selected heating stage) to a entrance point (which again can be inlet duct region 7A or any selected heating stage). Extraction of heated fluid may be made in a duct regions following the diffusing vane cascade 4 or, in an absence of the same, following the rotor blade cascade 3. Recycled fluid can be returned to an entrance of the stationary guide vane cascade 2 within the same heating stage or to the stationary guide vane cascade of any other preceding stage.

FIG. 3 shows an exemplary layout of an assembly including at least one rotary apparatus 100 with the fluid recycle arrangement 10 followed with at least one rotary apparatus 100-1 implemented without the recycling arrangement 10 or having the recycling arrangement 10 switched off/disabled. In such an event, the device 100-1 may act as a temperature booster for fluid heated in the rotary apparatus 100 equipped with the fluid recycling arrangement 10. By means of external booster heater 100-1, temperature of the heated fluid can be increased to a possible maximum (T₃<T₄). The layout of FIG. 3 may be modified to include two or more apparatuses 100 and/or two or more apparatuses 100-1 arranged in parallel or in series or in any other combination selected optimize rotating speed and aerodynamics. Additional heating implemented in the rotary apparatus(-es) 100-1 may be realized in one or more heating passes.

The apparatuses 100, 100-1 can be arranged on the same rotor shaft or on separate shafts. By having apparatuses 100, 100-1 arranged on different rotor shafts, direction of rotation and/or angular velocity/revolutions per minute (rpm) value for each apparatus 100, 100-1 can be independently regulated. Each shaft could have same or different rotational speed according to the specific duty required. In this manner, angular (rotational) speed of the apparatuses 100-100-1 can be adjusted independently. This is achieved by having each apparatus 100, 100-1 driven with a separate drive engine/motor. By using two or more separate apparatuses 100, 100-1, the costs of construction material can be optimized according to temperature and pressure.

In some configurations, an optional preheater 102 can be added in front of the rotary apparatus 100 in order to control temperature rise and to decrease recycle.

The apparatus 100 is configured such as to implement at least one heating stage/heating pass for fluid passing therethrough. Temperature rise (dT) achieved in one pass is within 10-200° C. Also greater temperatures (exceeding 200° C.) can be achieved in one heating pass. One-pass temperature rise (dT) depends on aerodynamic design of blades and gas physical properties. Energy input depends on mass flow, which, in turn, is determined by volumetric flow at choking conditions.

Control over the rotary apparatus comprising the recycling arrangement 10 can be implemented in a manner described herein below. By virtue of recycling arrangement 10, use of a frequency converter device can be omitted. However, it is noted that the apparatus 100 with the recycling arrangement 10 is fully functional also in presence of frequency converter. The following controls can be applied separately or with any combination, with or without frequency converter.
1. Recycle flow control:
   Control over a ratio between the recycle flow and the feed flow can be implemented with a number of flow regulating devices, such as control valves, configured to control a flow rate and/or pressure of recycled fluid, as described with regard to FIGS. 2A and 2B. This control changes the flow temperature at the outlet.
2. Inlet/outlet flow control:
   Provision of flow regulating devices for controlling flows at inlet and/or outlet flow allows to implement temperature control over the outlet flow by increasing or decreasing the recycle flow ratio and thus adjusting the heat input.
3. Pressure control to limit mass flow of the fluid through the rotary apparatus:
   By reducing operating pressure, the mass flow can be limited and hence the fluid (gas) mass flow through the rotary apparatus can be decreased. This control reduces recycle mass flow and, respectively, total mass flow through the rotary apparatus. The smaller is the mass flow, less shaft power is needed, which allows for utilizing a motor of a smaller size.
4. Combining the recycle flow control and the operating pressure control:
   By combining the recycle flow control and the operating pressure control, a smoother temperature rise can be achieved that reduces the shaft power duty at start-up.
5. Use of a preheater:
   The preheater can be used in implementing further control over the fluid flow through the rotary apparatus. Increasing inlet temperature of the rotary apparatus 100 with the preheater 102 (see FIG. 3) will decrease recycle.
6. Use of a heat sink:
   Provision of a heat sink for the recycle flow enable gradual heat-up of the rotary apparatus 100.

The rotary apparatus 100 may also be designed without flow controlling device(s) (such as A, B and C shown on FIG. 2B). In this case, the apparatus may be controlled with a frequency controller, or the flow control arrangement may be omitted.

In the apparatus 100, fluid (gas) inlet flow can be increased to a point where choked flow takes place in the inlet region or any other part of the duct. At this point it is not possible to increase throughput at a constant inlet pressure. Choked flow will limit volumetric flow through the apparatus. The present invention enables keeping the flow of fluid (gas) through the apparatus constant (also at choking flow conditions) by controlling the gas flow at the inlet and by recycling at least a part of said gas using the gas circulation arrangement 10. By increasing the amount of recycled gas, the feed gas flow can be decreased, respectively. By controlling the recycle flow rate, it is also possible to control fluid temperature at the outlet.

On the contrary to gas compressors or other conventional turbomachines, where recycling of gases typically results in loss of energy because of a pressure drop, practically no energy loss has been observed in the rotary apparatus 100 equipped with the gas recirculation arrangement 10. An important advantage of recycling of fluids via the arrangement 10 is that the rotor shaft speed (meaning angular velocity/revolutions per minute (rpm) value for the rotor shaft) can be decreased by increasing volumetric flow through the rotary apparatus 100. Accordingly, the rotor diameter (diameter of the circle created by rotating rotor blade tips) can also be increased in order to maintain beneficial aerodynamics in the rotor and stators. Rotor blade speed defines velocity of fluid (gas) propagating through the apparatus 100, as well as temperature rise downstream the impeller (e.g. in the diffuser). Hence, optimal rotor blade speed may then be maintained with a lower rotating speed of the rotor shaft. This means that the apparatus 100 can be designed for a standard electric motor and there is no need for a gearbox.

Tables 1-3 demonstrate functionality of the apparatus 100 equipped with the fluid (re) circulation arrangement 10 shown on FIG. 1. Although the apparatus 100 will change its aerodynamic performance from less optimal to optimal, using simplifications, the advantages of flow recycling can be shown. To indicates the temperature of fluidic feed; T₂ indicates the temperature of fluidic feed admixed with recycled fluid, and T₃ indicates the temperature of fluid at the apparatus outlet (these indications pertain to FIGS. 1, 2B and 3). Delta T (dT) indicates temperature rise per a heating pass/heating stage. Calculations were performed with following simplifications and assumptions:
Feed inlet temperature was assumed to be 0° C.;
Volumetric flow through the apparatus 100 (duct 11) was assumed to be constant;
Temperature rise through the apparatus 100 was assumed to be constant;
Specific heat was assumed to be constant;
Gas density was assumed as 1 kg/m³ at pressure 1 bar (0.1 MPa).
Pressure losses in recycling were not taken into account.

Results presented in Tables 1-3 are equally applicable to the apparatus 100 with internal recycling route and the same with the external recycling route.

Table 1 is illustrative of an example (Example 1), which shows how mass flow of fluidic feed flowing through the apparatus 100 decreases and the temperature rises, accordingly, when the ratio between the recycled fluid and the feed fluid increases. Operating pressure has been preserved constant (1 bar). Without recycle, the mass flow rate of the fluidic feed is 5000 kg/h and the outlet temperature (T₃) is 120° C. (Table 1, column I). When the recycled fluid to feed ratio is about 9:1, the feed mass flow is about 100 kg/h and the outlet temperature is 1200° C. (Table 1, column IV).

TABLE 1

| | I | II | III | IV |
|---|---|---|---|---|
| Pressure, bar | 1 | 1 | 1 | 1 |
| Feed, kg/h | 5000 | 1745 | 535 | 101 |
| Recycle, kg/h | 0 | 1735 | 1620 | 909 |
| Mass flowthrough (100) | 5000 | 3480 | 2155 | 1010 |
| Vol flowthrough, m³/h | 5000 | 5004 | 5002 | 5003 |
| T₀, ° C. | 0 | 0 | 0 | 0 |
| T₃, ° C. | 120 | 240 | 480 | 1200 |
| T₂, ° C. | 0 | 120 | 361 | 1080 |
| Duty, kW | 167 | 116 | 71 | 34 |
| dT (100) | 120 | 120 | 119 | 120 |

Table 2 illustrates a second example, where pressure was 2 bar (0.2 MPa) and the feed mass flow was 10,000 kg/h without recycle. This example shows how by manipulating the recycle mass flow and pressure it is possible to reduce the total mass flow and to control the shaft power of the apparatus 100. Upon starting the heating without recycle at 1 bar (as in Example 1, Table 1), the heat duty is 167 kW. When the pressure is increased to 2 bar, the shaft power can be almost the same (143 kW) when the feed flow is 1070 kg/h, while the recycle flow is about three times of the feed flow and the outlet temperature is 480° C. (Table 2, column III).

TABLE 2

| | I | II | III | IV |
|---|---|---|---|---|
| Pressure, bar | 2 | 2 | 2 | 2 |
| Feed, kg/h | 10000 | 3490 | 1070 | 202 |
| Recycle, kg/h | 0 | 3490 | 3240 | 1818 |
| Mass flowthrough (100) | 10000 | 6980 | 4310 | 2020 |
| Vol flowthrough, m³/h | 5000 | 5023 | 5002 | 5003 |
| T₀, ° C. | 0 | 0 | 0 | 0 |
| T₃, ° C. | 120 | 240 | 480 | 1200 |
| T₂, ° C. | 0 | 120 | 361 | 1080 |
| Duty, kW | 333 | 233 | 143 | 67 |
| dT (100) | 120 | 120 | 119 | 120 |

Table 3 illustrates a third example, where delta T (dT) is 300° C., i.e. a greater number of heating passes/heating stages has been used (five (5) vs four (4) in Examples 1 and 2). In this example, less recycle is needed.

TABLE 3

| | I | II | III | IV | V |
|---|---|---|---|---|---|
| Pressure, bar | 1 | 1 | 1 | 1 | 2 |
| Feed, kg/h | 5000 | 1190 | 525 | 292 | 564 |
| Recycle, kg/h | 0 | 1190 | 1045 | 875 | 1750 |
| Mass flowthrough (100) | 5000 | 2380 | 1570 | 1167 | 2314 |
| Vol flowthrough, m³/h | 5000 | 4994 | 5013 | 5011 | 5001 |
| T₀, ° C. | 0 | 0 | 0 | 0 | 0 |
| T₃, ° C. | 300 | 600 | 900 | 1200 | 1200 |
| T₂, ° C. | 0 | 300 | 599 | 900 | 908 |
| Duty, kW | 417 | 198 | 131 | 97 | 188 |
| dT (100) | 300 | 300 | 301 | 300 | 292 |

It is further possible to control temperature rise and mass flow in the apparatus 100 by using a preheater, as described with regard to FIG. 3.

Upon connecting at least two apparatuses 100, 100-1 in parallel or in series, an assembly can be established. Connection between said apparatuses can be mechanical and/or functional. Functional (in terms of processing similar feedstocks, for example) connection can be established upon association between at least two physically integrated- or non-integrated individual apparatus units 100. In a latter case, association between the at least two apparatuses 100 can be established via a number of auxiliary installations. In some configurations, the assembly comprises the at least two apparatuses at least functionally connected via their central shafts such, as to mirror each other. Such mirrored configuration can be further defined as having at least two apparatuses 100 mechanically connected in series (in a sequence), whereas functional (e.g. in terms of inputting heat into fluids) connection can be viewed as connection in parallel (in arrays). In some instances, the aforesaid “mirrored” assembly can be further modified to comprise at least two inlets and a common exhaust (discharge) stage placed essentially in the center of the assembly (not shown).

Upon connecting the at least one rotary apparatus 100, 100-1 or the assembly of at least two apparatuses 100, 100-1 to at least one heat-consuming unit, an arrangement may be established. The apparatus(es) 100, 100-1 may be connected to the heat-consuming unit or units directly or indirectly, e.g. through a number of heat exchangers. The heat-consuming unit may be provided as any one of: a furnace, an oven, a kiln, a reactor, a heater, a burner, an incinerator, a boiler, a dryer, a conveyor, or a combination thereof.

Said arrangement including the at least one apparatus 100, 100-1 and at least one heat-consuming unit may be provided as a part of a heat-consuming system configured as a facility adapted to carry out at least one heat-consuming process including, but not limited to the: steel manufacturing; cement manufacturing; production of hydrogen and/or synthetic gas, such as steam-methane reforming; conversion of methane to hydrogen, fuels and/or chemicals; conversion of plastic and/or organic materials, such as plastic and/or organic waste, to useable products (recycling); thermal energy storage, such as high temperature heat storage; processes related to oil- and/or petrochemical industries; catalytic processes for endothermic reactions; processes for disposal of harmful and/or toxic substances by incineration, and processes for manufacturing high-temperature materials, such as glass wool, carbon fiber and carbon nanotubes, brick, ceramic materials, porcelain and tile.

In an aspect, a method for recycling fluids in the rotary apparatus is provided, the method comprises at least the following steps:
(a) obtaining a rotary apparatus 100 for inputting thermal energy into fluids, comprising:
   a rotor comprising at least one row of rotor blades arranged over a circumference of a rotor hub mounted on a rotor shaft 1 and forming at least one rotor blade cascade 3, respectively, and
   a plurality of stationary vanes arranged into at least one stationary vane cascade adjacent to said at least one rotor blade cascade,
(b) supplying optionally preheated fluid into the rotary apparatus through at least one inlet 7, and operating the rotary apparatus such that thermal energy is imparted to fluid propagating inside the casing between at least one inlet and at least one outlet by virtue of series of energy transformations occurring when said fluid successively passes through rotating blades and stationary vanes, whereby a stream of heated fluid is generated, and
(c) recycling a part of heated fluid by returning said heated fluid, via the fluid circulation arrangement, into a region of the duct between at least one inlet and at least one rotor blade cascade, when said fluid propagates in the duct between at least one inlet and at least one outlet.

In an embodiment, the plurality of stationary vanes arranged adjacent to said at least one rotor blade cascade form stationary vane cascades such that a headmost stationary vane cascade 2, 2(h) configured as a stationary guide vane cascade receives fluid entering the rotary apparatus through at least one inlet 7 and directs said fluid towards a subsequent rotor blade cascade, and the method comprises recycling the part of heated fluid by returning said heated fluid, via the fluid circulation arrangement 10, to an entrance of said stationary headmost vane cascade 2, 2(h), when fluid propagates in the duct between at least one inlet and at least one outlet.

The method is preferably implemented in the rotary apparatus 100 comprising the fluid (re) circulation/recycling arrangement according to the embodiments described herein above.

It is clear to a person skilled in the art that with the advancement of technology the basic ideas of the present invention may be implemented and combined in various ways. The invention and its embodiments are thus not limited to the examples described herein above, instead they may generally vary within the scope of the appended claims.

1. A rotary apparatus for inputting thermal energy into fluids, comprising:
a rotor comprising at least one row of rotor blades arranged over a circumference of a rotor hub mounted on a rotor shaft and forming at least one rotor blade cascade, respectively, and
a plurality of stationary vanes arranged into at least one stationary vane cascade adjacent to said at least one rotor blade cascade,
wherein the rotor and the plurality of stationary vanes are enclosed in a duct formed in a casing between at least one inlet and at least one outlet,
the rotary apparatus being configured to impart thermal energy to fluid flowing in the duct between at least one inlet and at least one outlet by virtue of series of energy transformations occurring when said fluid successively passes through rotating blades and stationary vanes, whereby a stream of heated fluid is generated,
wherein the rotary apparatus further comprises a fluid circulation arrangement configured to return a part of heated fluid into a duct region between at least one inlet and at least one rotor blade cascade.

2. The apparatus of claim 1, wherein the plurality of stationary vanes is arranged into at least one stationary vane cascade upstream of the at least one rotor blade cascade, said stationary vane cascade being configured as a stationary guide vane cascade, and wherein the fluid circulation arrangement is configured to return the part of heated fluid to an entrance of said stationary guide vane cascade.

3. The rotary apparatus of claim 2, wherein the stationary guide vane cascade is a headmost stationary vane cascade which receives fluid entering the rotary apparatus through at least one inlet and directs said fluid towards a subsequent rotor blade cascade, and wherein the fluid circulation arrangement is configured to return the part of heated fluid to an entrance of said headmost stationary vane cascade.

4. The rotary apparatus of claim 1, wherein the plurality of stationary vanes is further arranged into at least one stationary vane cascade downstream of the at least one rotor blade cascade, said stationary vane cascade being configured as a stationary diffusing vane cascade.

5. The rotary apparatus of claim 4, wherein the fluid circulation arrangement is configured to extract a part of fluid exiting the diffusing vane cascade.

6. The rotary apparatus of claim 1, wherein the fluid circulation arrangement is configured to extract a part of heated fluid exiting the apparatus via at least one outlet.

7. The rotary apparatus of claim 1, comprising at least two rotor blade cascades coaxially arranged on the rotor shaft.

8. The rotary apparatus of claim 7, wherein the fluid circulation arrangement is configured to return the part of heated fluid into a duct region between at least one inlet and any one of said at least two rotor blade cascades.

9. The rotary apparatus of claim 7, further comprising a stationary guide vane cascade arranged upstream of a first rotor blade cascade of said at least two rotor blade cascades and optionally upstream of each subsequent rotor blade cascade, and a stationary diffusing vane cascade arranged downstream of at least a rearmost rotor blade cascade, respectively, and wherein the fluid circulation arrangement is configured to return the part of heated fluid exiting the diffusing vane cascade to the entrance of the stationary guide vane cascade arranged upstream of the first rotor blade cascade.

10. The rotary apparatus of claim 1, wherein the fluid circulation arrangement is arranged inside the casing.

11. The rotary apparatus of claim 10, wherein the fluid circulation arrangement is configured as an internal piping or a conduit, a flowguide device or devices, or as an internal secondary shell.

12. The rotary apparatus of claim 1, wherein the fluid circulation arrangement is configured as a piping arranged outside the casing.

13. The rotary apparatus of claim 2, wherein a portion of the duct between an exit from the rotor blade cascade and an entrance to the stationary guide vane cascade is essentially free of blades/vanes.

14. The rotary apparatus of claim 4, wherein a portion of the duct between an exit from the stationary diffusing vane cascade and an entrance to the stationary guide vane cascade is essentially free of blades/vanes.

15. The rotary apparatus of claim 1, wherein the fluid circulation arrangement comprises a number of flow regulating devices, such as control valves, configured to control a flow rate and/or pressure of recycled fluid.

16. Use of the rotary apparatus according to claim 1 for heating fluids in an absence of a frequency converter device.

17. Use of the rotary apparatus according to claim 1 with a drive engine, such as motor, configured to rotate the rotor shaft without a gearbox.

18. An assembly comprising at least two rotary apparatuses according to claim 1, at least functionally connected in parallel or in series.

19. The assembly of claim 18, wherein in at least one of said at least two rotary apparatuses the fluid circulation arrangement is disabled or omitted.

20. An assembly comprising at least one rotary apparatus according to claim 1, and a preheater device arranged upstream of the at least one rotary apparatus.

21. An arrangement comprising at least one rotary apparatus according claim 1, connected to at least one heat-consuming unit.

22. The arrangement of claim 21, wherein the heat-consuming unit is any one of: a furnace, an oven, a kiln, a reactor, a heater, a burner, an incinerator, a boiler, a dryer, a conveyor, or a combination thereof.

23. A method for recycling fluids in the rotary apparatus, the method comprising:
(a) obtaining a rotary apparatus for inputting thermal energy into fluids, comprising:
a rotor comprising at least one row of rotor blades arranged over a circumference of a rotor hub mounted on a rotor shaft and forming at least one rotor blade cascade, respectively, and
a plurality of stationary vanes arranged into at least one stationary vane cascade adjacent to said at least one rotor blade cascade,
the rotor and the plurality of stationary vanes being enclosed in a duct formed in a casing between at least one inlet and at least one outlet,
(b) supplying optionally preheated fluid into the rotary apparatus through at least one inlet, and operating the rotary apparatus such that thermal energy is imparted to fluid propagating inside the casing between at least one inlet and at least one outlet by virtue of series of energy transformations occurring when said fluid successively passes through rotating blades and stationary vanes, whereby a stream of heated fluid is generated, and
(c) recycling a part of heated fluid by returning said heated fluid, via the fluid circulation arrangement, into a region of the duct between at least one inlet and at least one rotor blade cascade, when said fluid propagates in the duct between at least one inlet and at least one outlet.

24. The method of claim 23, comprising recycling fluids heated to the temperature essentially equal to or exceeding about 400 degrees Celsius (° C.).

25. The method of claim 23, wherein recycling comprises directing the part of heated fluid towards an entrance to at least one stationary vane cascade arranged upstream of the at least one rotor blade cascade and configured as a stationary guide vane cascade.

26. The method of claim 25, wherein the stationary guide vane cascade is a headmost stationary vane cascade which receives fluid entering the rotary apparatus through at least one inlet and directs said fluid towards a subsequent rotor blade cascade, and wherein recycling comprises directing the part of heated fluid to an entrance of said headmost stationary vane cascade.

27. The method of claim 23, wherein recycling comprises directing the part of heated fluid into the region of the duct between at least one inlet and at least one rotor blade cascade through the fluid circulation arrangement arranged inside the casing and configured as an internal piping or a conduit, a flowguide device or devices, or as an internal secondary shell.

28. The method of claim 23, wherein recycling comprises directing the part of heated fluid into the region of the duct between at least one inlet and at least one rotor blade cascade via an external piping.

29. The method of claim 23, in which the heated fluid is generated by at least one rotary apparatus comprising at least two rotor blade cascades coaxially arranged on the rotor shaft, and wherein recycling comprises directing the part of heated fluid into the duct region between at least one inlet and any one of the rotor blade cascades.

30. The method of claim 23, comprising adjusting outlet temperature of the fluid propagated through the duct by regulating at least a flow rate of fluid recycled via the fluid circulation arrangement.

31. The method of claim 23, wherein the heated fluid generated in the rotary apparatus is gas.

32. The method of claim 31, wherein the heated fluid generated in the rotary apparatus is any one of: air, steam (H₂O), nitrogen (N₂), hydrogen (H₂), oxygen (O₂), carbon dioxide (CO₂), carbon monoxide (CO), nitrogen oxides (NOx), ammonia (NH₃), sulfur dioxide (SO₂), halogen-containing gas, hydrocarbon-containing gas, or any combination thereof.

33. The method of claim 23, wherein the rotary apparatus is driven with an electrical motor optionally using electrical energy obtainable from renewable sources.
